(19) United States
(12) Patent Application Publication
(10) Pub. No.: US 2022/0100925 A1
(43) Pub. Date: Mar. 31, 2022

(54) OPTIMIZATION APPARATUS, OPTIMIZATION METHOD, AND COMPUTER READABLE RECORDING MEDIUM

(71) Applicant: NEC Corporation, Minato-ku, Tokyo (JP)

(72) Inventor: Yoshiyuki OHNO, Tokyo (JP)

(73) Assignee: NEC Corporation, Minato-ku, Tokyo (JP)

(21) Appl. No.: 17/420,975

(22) PCT Filed: Jan. 18, 2019
(86) PCT No.: PCT/JP2019/001549

§ 371 Date: Jul. 6, 2021

(51) Int. Cl. G06F 30/20; G06F 7/535

(52) U.S. Cl. CPC G06F 30/20; G06F 2111/10; G06F 7/535

(57) ABSTRACT

An optimization apparatus 1 includes: a division unit 2 that divides a total vector length into divided vector lengths that are equal to or shorter than a maximum vector length so that the computation efficiency becomes equal to or higher than a predetermined value in vector computation to be executed by a vector computation processor; and a generation unit 3 that generates a code to be used in the vector computation based on the divided vector lengths.

### TECHNICAL FIELD

The present invention relates to an optimization apparatus and an optimization method that optimize a program, and further relates to a computer readable recording medium having recorded therein a program for realizing the same.

### BACKGROUND ART

Vector computation is a method of increasing the speed of computation by executing the same computation with respect to a plurality of pieces of data in parallel. Also, in a processor that can execute such vector computation, instructions used in vector computation are generated using a generation apparatus (e.g., a code generator, a compiler, and the like) based on the maximum vector length of the processor.

The reason why the maximum vector length is used is because the computation efficiency is improved by performing a large amount of computation under one instruction. However, in a case where the maximum vector length is used, dividing a vector length handled in vector computation (the total vector length) in units of the maximum vector length may leave a short vector length, which causes a reduction in the computation efficiency.

In view of this, Patent document 1 discloses a technique to avoid vector computation that uses a short vector length, which reduces the computation efficiency, and improve the computation efficiency by dividing the total vector length VL into two equal halves and using the equally divided vector lengths VL1 and VL2 in a case where the following condition is satisfied: the maximum vector length (M)<the total vector length VL<twice the maximum vector length (2M).

### LIST OF RELATED ART DOCUMENTS

### Patent Document

Patent document 1: Japanese Patent Laid-Open Publication No. H5-40779

### SUMMARY

### Technical Problems

However, the technique disclosed in Patent document 1 cannot improve the computation efficiency of vector computation under the conditions other than the aforementioned condition.

An example object of the present invention is to provide an optimization apparatus, an optimization method, and a computer readable recording medium that improve the computation efficiency of vector computation.

### Solution to the Problems

To achieve the aforementioned object, an optimization apparatus according to an example aspect of the present invention includes:

a division unit that divides a total vector length into divided vector lengths that are equal to or shorter than a maximum vector length so that computation efficiency becomes equal to or higher than a predetermined value in vector computation to be executed by a vector computation processor; and

a generation unit configured to generate a code to be used in the vector computation based on the divided vector lengths.

Also, to achieve the aforementioned object, an optimization method according to an example aspect of the present invention includes:

(a) a step of dividing a total vector length into divided vector lengths that are equal to or shorter than a maximum vector length so that computation efficiency becomes equal to or higher than a predetermined value in vector computation to be executed by a vector computation processor; and

(b) a step of generating a code to be used in the vector computation based on the divided vector lengths.

Furthermore, to achieve the aforementioned object, a computer readable recording medium according to an example aspect of the present invention has recorded therein a program including an instruction that causes a computer to execute:

(a) a step of dividing a total vector length into divided vector lengths that are equal to or shorter than a maximum vector length so that computation efficiency becomes equal to or higher than a predetermined value in vector computation to be executed by a vector computation processor; and

(b) a step of generating a code to be used in the vector computation based on the divided vector lengths.

### Advantageous Effects of the Invention

As described above, according to the present invention, the computation efficiency of vector computation can be improved.

### BRIEF DESCRIPTION OF THE DRAWINGS

FIG. 1 is a diagram illustrating one example of an optimization apparatus.

FIG. 2 is a diagram illustrating the relationships between the vector length, the computation period, and the computation efficiency.

FIG. 3 is a diagram illustrating the relationship between the vector length and the computation efficiency for a case where vector computation is performed with respect to the total vector length in units of the maximum vector length.

FIG. 4 is a diagram illustrating the relationship between the vector length and the computation efficiency for a case where vector computation is performed with respect to the total vector length in units of the divided vector lengths.

FIG. 5 is a diagram illustrating one example of a system that includes the optimization apparatus.

FIG. 6 is a diagram illustrating one example of a system that includes the optimization apparatus.

FIG. 7 is a diagram for describing the determination of costs based on vector instruction sequences.

FIG. 8 is a diagram illustrating one example of a data structure of cost information.

FIG. 9 is a diagram illustrating one example of calculation of the divided vector lengths with use of the chunk vector lengths.

FIG. 10 is a diagram illustrating one example of system operations.

FIG. 11 is a diagram illustrating one example of system operations.

FIG. 12 is a diagram illustrating one example of a computer that realizes the optimization apparatus.

### EXAMPLE EMBODIMENT

### Example Embodiment

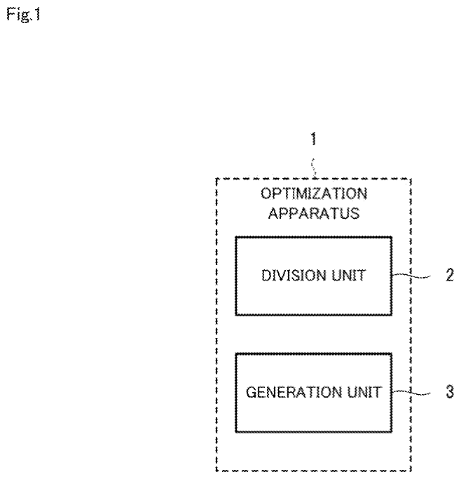

The following describes an example embodiment of the present invention with reference to FIG. 1 to FIG. 12.

[Apparatus Configuration]

First, a configuration of an optimization apparatus 1 according to the present example embodiment will be described using FIG. 1. FIG. 1 is a diagram illustrating one example of the optimization apparatus.

The optimization apparatus illustrated in FIG. 1 is an apparatus for improving the computation efficiency of vector computation. Also, as illustrated in FIG. 1, the optimization apparatus 1 includes a division unit 2 and a generation unit 3.

Among these, the division unit 2 divides the total vector length into divided vector lengths that are equal to or shorter than the maximum vector length so that the computation efficiency becomes equal to or higher than a predetermined value in vector computation executed by a vector computation processor. The generation unit 3 generates codes to be used in vector computation based on the divided vector lengths.

Here, the total vector length handled in vector computation indicates the number of all elements targeted for vector computation. The maximum vector length indicates the number of elements that can be computed simultaneously by the vector computation processor. The computation efficiency is denoted by the vector length/the computation period. The predetermined value indicates the computation efficiency with which highly efficient vector computation can be performed.

As such, in the present example embodiment, the vector computation processor executes vector computation in units of the divided vector lengths, with which the computation efficiency of vector computation becomes equal to or higher than the predetermined value and which have been divided to be equal to or shorter than the maximum vector length; therefore, the computation efficiency can be improved.

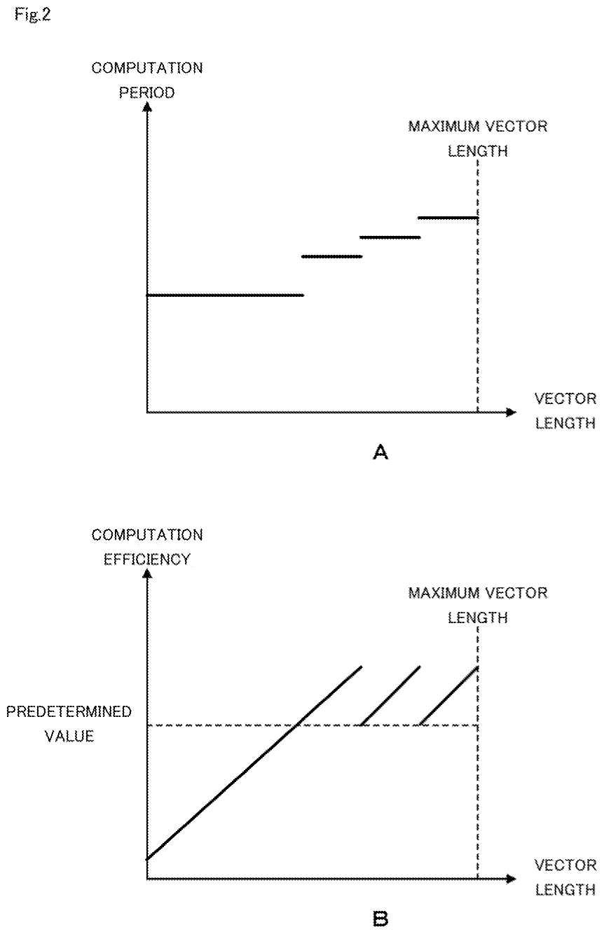

The reason therefor will be described using FIGS. 2, 3, and 4. FIG. 2 is a diagram illustrating the relationships between the vector length, the computation period, and the computation efficiency. A of FIG. 2 is a diagram illustrating the relationship between the vector length and the computation period. B of FIG. 2 is a diagram illustrating the relationship between the vector length and the computation efficiency.

First, with regard to the vector computation processor, the computation period varies depending on the vector length as illustrated in A of FIG. 2. Also, as illustrated in A of FIG. 2, a short vector length does not necessarily shorten the computation period. Furthermore, as illustrated in B of FIG. 2, the longer the vector length, the higher the computation efficiency (the computation efficiency=the vector length/the computation period). Moreover, as illustrated in B of FIG. 2, there are cases where a vector length other than the maximum vector length leads to high computation efficiency.

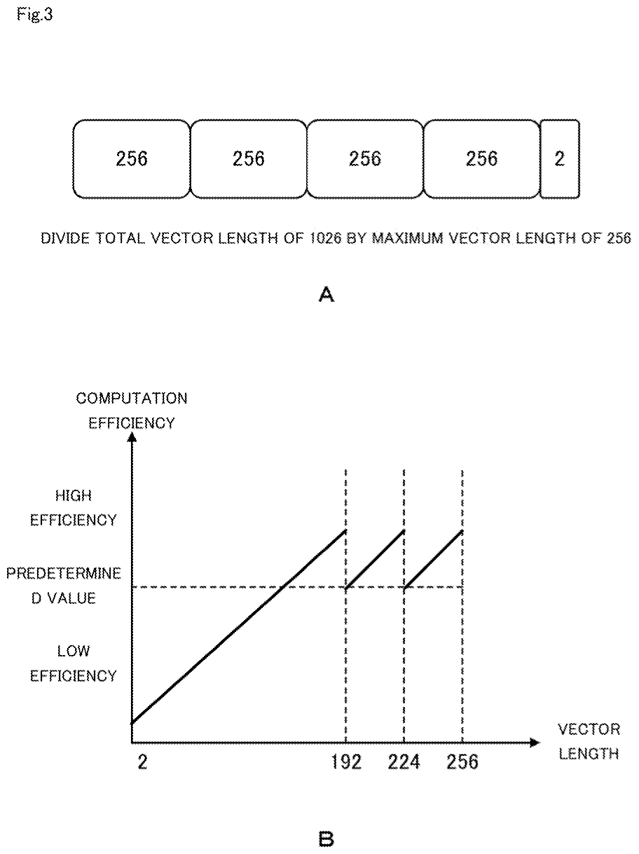

FIG. 3 is a diagram illustrating the relationship between the vector length and the computation efficiency for a case where vector computation is performed with respect to the total vector length in units of the maximum vector length. A and B of FIG. 3 are diagrams illustrating a case where, as a result of performing vector computation with respect to a total vector length of 1026 in units of a maximum vector length of 256, a vector length of 2 with low computation efficiency is left in the end, thereby reducing the overall computation efficiency of vector computation.

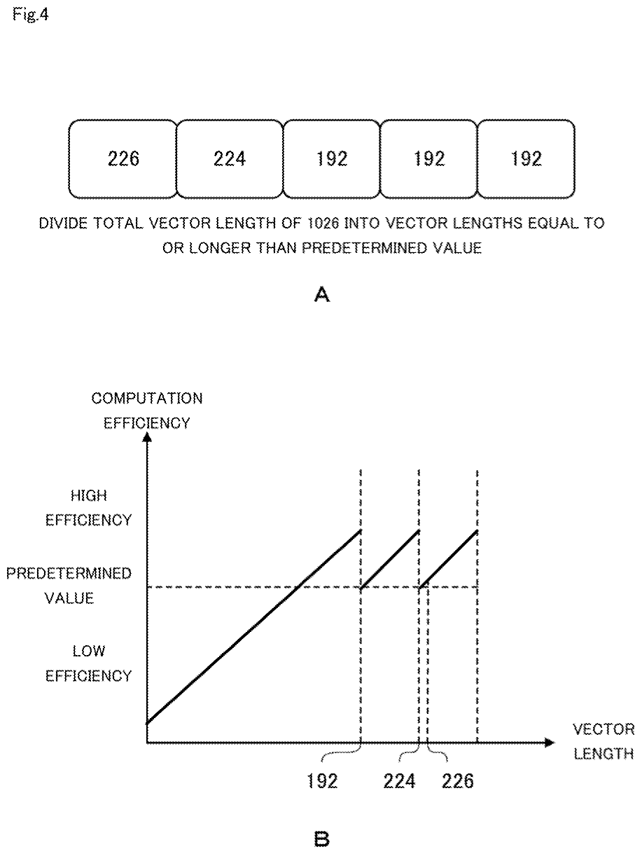

In contrast, FIG. 4 is a diagram illustrating the relationship between the vector length and the computation efficiency for a case where vector computation is performed with respect to the total vector length in units of the divided vector lengths. A and B of FIG. 4 are diagrams illustrating a case where, as a result of performing vector computation with respect to a total vector length of 1026 in units of divided vector lengths of 226, 224, 192, 192, and 192, the overall computation efficiency of vector computation is not reduced.

That is to say, by executing vector computation with the computation efficiency equal to or higher than the predetermined value with use of the divided vector lengths with high computation efficiency, the overall computation efficiency of vector computation can be improved as illustrated in FIG. 4.

[System Configuration]

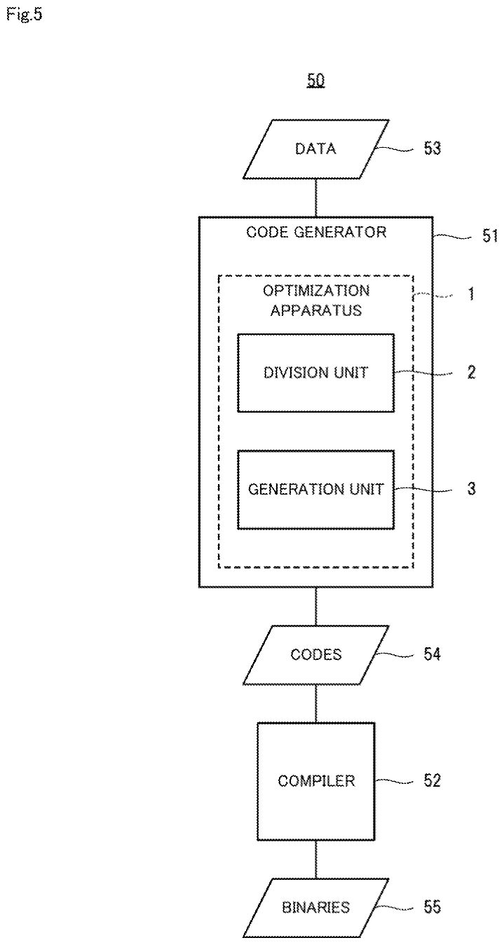

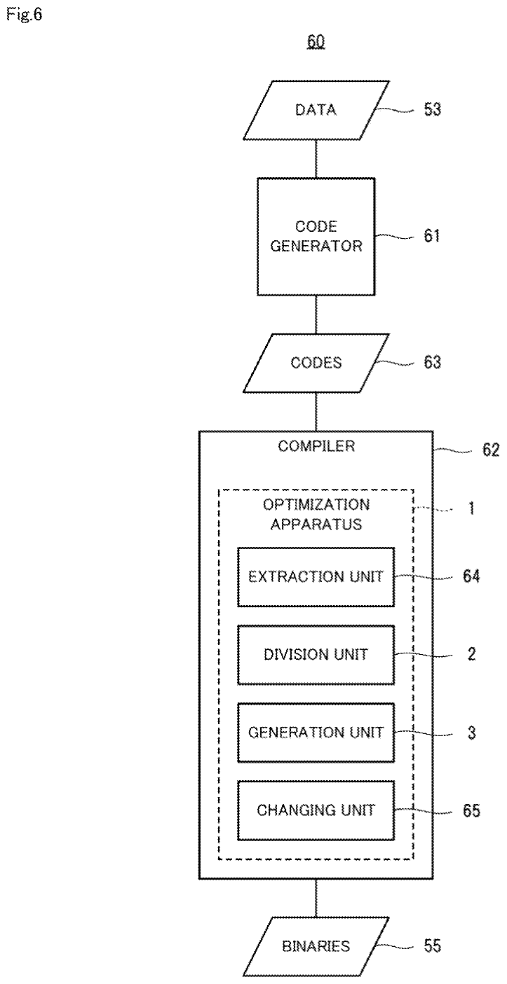

Next, the configuration of the optimization apparatus 1 according to the present example embodiment will be described more specifically using FIGS. 5 and 6. FIGS. 5 and 6 are diagrams illustrating examples of a system that includes the optimization apparatus.

(1) A description is now given of a system 50.

The system 50 according to the present example embodiment illustrated in FIG. 5 includes a code generator 51 and a compiler 52. Also, the code generator 51 illustrated in FIG. 5 includes the optimization apparatus 1.

The code generator 51 generates codes based on input data. Specifically, the code generator 51 obtains data 53 that includes, for example, parameters to be used in vector computation, and generates codes 54 used to generate a binary 55 to be used in the vector computation processor. The code generator 51 also determines the divided vector lengths with which the computation efficiency becomes equal to or higher than the predetermined value, and generates codes for vector computation based on the determined divided vector lengths.

The compiler 52 generates the binary 55 based on the obtained codes 54. Specifically, using the codes 54 generated by the code generator 51, the compiler 52 generates the binary 55 to be used in the vector computation processor.

(2) A description is now given of a system 60.

The system 60 according to the present example embodiment illustrated in FIG. 6 includes a code generator 61 and a compiler 62. Also, the compiler 62 illustrated in FIG. 6 includes the optimization apparatus 1. The compiler 62 includes an extraction unit 64 and a changing unit 65 in addition to the division unit 2 and the generation unit 3.

The code generator 61 generates codes based on input data. Specifically, the code generator 61 obtains data 53 that includes, for example, parameters to be used in vector computation, and generates codes 63 for generating a binary 55 to be used in the vector computation processor.

The compiler 62 generates the binary 55 based on the obtained codes 63. Specifically, using the codes 63 generated by the code generator 61, the compiler 62 generates the binary 55 to be used in the vector computation processor.

Furthermore, the compiler 62 first extracts codes to be used in vector computation from the codes 63. Subsequently, the compiler 62 determines the divided vector lengths with which the computation efficiency becomes equal to or higher than the predetermined value using the extracted codes, and generates codes to be used in vector computation based on the determined divided vector lengths.

Thereafter, the compiler 62 generates the code 54 by changing the codes which are included in the codes 63 generated by the code generator 61 and which have been extracted to be used in vector computation, into the codes which have been generated by the compiler 62 to be used in vector computation. See FIG. 5.

Specifically, the compiler 62 converts codes which are included in the codes 63 and which correspond to vector computation that uses the maximum vector length as in conventional cases, into codes corresponding to vector computation that uses the divided vector lengths.

Thereafter, using the codes 54, the compiler 62 generates the binaries 55 to be used in the vector computation processor.

In a case where codes to be used in vector computation are generated by the compiler 62, the extraction unit 64 first extracts codes corresponding to vector computation. Subsequently, the extraction unit 64 extracts parameters to be used to determine the divided vector lengths from the extracted codes. Thereafter, the extraction unit 64 outputs the extracted parameters to the division unit 2.

In a case where binaries to be used in vector computation is generated by the compiler 62, the changing unit 65 generates the codes 54 by changing the codes which are included in the codes 63 generated by the code generator 61 and which have been extracted to be used in vector computation, into the codes which have been generated by the compiler 62 to be used in vector computation. Thereafter, the changing unit 65 outputs the generated codes 54 to the compiler 62.

Below is a specific description of optimization.

The division unit 2 obtains parameters related to vector computation (e.g., the total vector length, the maximum vector length, and the like), and with use of information (costs) which is stored in a non-illustrated storage unit in advance and which indicates costs, divides the total vector length into the divided vector lengths that are equal to or shorter than the maximum vector length so that the computation efficiency becomes equal to or higher than the predetermined value. The storage unit may be provided in the system 50 or 60, or may be provided outside the system 50 or 60.

Specifically, the division unit 2 (A) divides the total vector length into the divided vector lengths with use of costs that are respectively associated with vector lengths. Alternatively, the division unit 2 (B) divides the total vector length into the divided vector lengths with use of costs that are respectively associated with chunk vector lengths that have been divided using the maximum vector length as a reference.

The costs are set based on the computation periods of respective vector lengths. Specifically, vector computation is executed through an experiment, a simulation, and the like with respect to each of vector lengths from the minimum vector length (one element) to the maximum vector length, the computation periods of respective vector lengths are measured, and the measured computation periods are used as the costs of respective vector lengths.

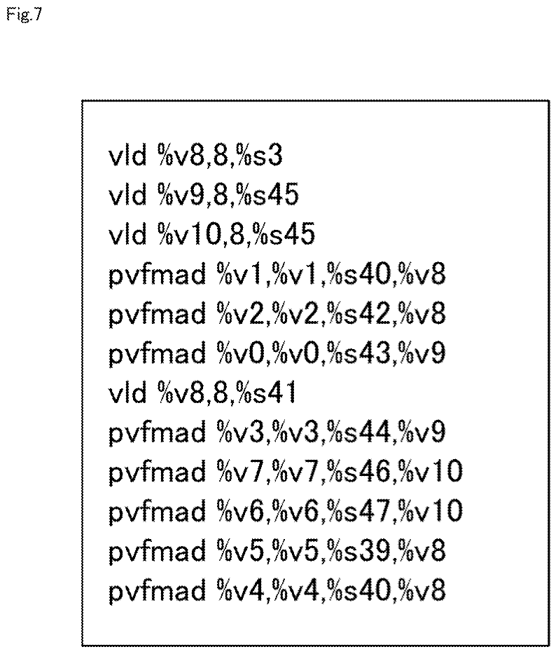

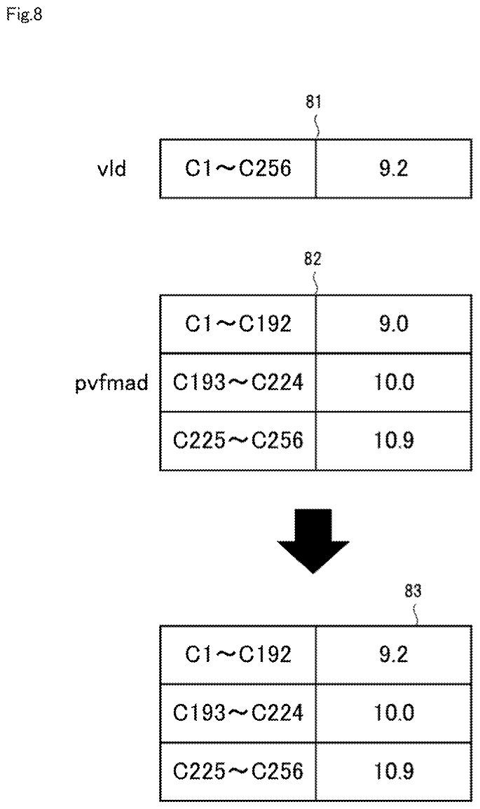

Note that the costs may be determined based on vector instruction sequences included in codes used in vector computation. A specific description will now be provided using FIGS. 7 and 8. FIG. 7 is a diagram for describing the determination of the costs based on the vector instruction sequences. FIG. 8 is a diagram illustrating one example of a data structure of cost information.

The vector instruction sequences can be, for example, vector instruction sequences of the innermost loop illustrated in FIG. 7 (scalar instructions are omitted). Also, in FIG. 7, vector instructions are “vld” and “pvfmad”. For example, pieces of cost information 81, 82 illustrated in FIG. 8 are possible.

Furthermore, cost information 83 may be generated using the maximum value of Ci (i=1 to 256) of the pieces of cost information 81, 82 with reference to the pieces of cost information 81, 82, and used as the cost of the codes that include the vector instruction sequences illustrated in FIG. 7 per se. Note that although the maximum value is used in the example of FIG. 8, a sum may be used.

A division method of (A) will now be described.

The division unit 2 determines the divided vector lengths with use of the total vector length VL_{Total}, the maximum vector length VL_{Max}, and the costs Ci that are respectively set for vector lengths of i (=1, 2, . . . , VL_{Max}), and calculates the number Xi of each of the determined divided vector lengths. Specifically, the division unit 2 calculates the number Xi of each of the divided vector lengths by solving the integer programming problems indicated by Math. 1.

Variable: Xi (i=1,2, . . . ,VL_{Max})

Objective function: sum(Ci×Xi)

Constraint condition: Xi≥0, sum(i×Xi)=VL_{Total} (Math. 1)

For example, in a case where the total vector length VL_{Total}=1026, the maximum vector length VL_{Max}=256, the costs C1 . . . C192=9.0 [s], the costs C193 . . . C224=10.0 [s], and the costs C225 . . . C256=10.9 [s], the number Xi is calculated for each of the divided vector lengths as indicated by Math. 2.

Variable: Xi (i=1,2, . . . ,256)

Objective function: sum(Ci×Xi)

Constraint condition: Xi≥0, sum(i×Xi)=1026 (Math. 2)

The number of each divided vector length:
X187=1
X188=2
X207=1
X256=1

That is to say, the total vector length is divided into divided vector lengths of 187, 188, 188, 207, and 256. In this way, the vector computation processor can perform vector computation with high efficiency.

### Example Modification

As an example modification of (A), the total vector length may be divided in units of a reference divided vector length. Note that in a case where the division leaves a remainder of a vector length that is shorter than the reference divided vector length, the vector length that is left as the remainder is divided and added to the reference divided vector length so that the result of the addition is equal to or shorter than the maximum vector length.

For example, using the maximum vector length VL_{Max}=256, the total vector length VL_{Total}=1026 is divided by a reference divided vector length of 192. As a result, the total vector length VL_{Total} is divided into 192, 192, 192, 192, 192, and 66.

However, as 66 leads to low efficiency, 66 is added to 192 (192+66=258). However, as 258 is larger than the maximum vector length 256, 256 is subtracted from 258 (258−256=2). Then, 2 is added to another 192, which results in 194.

That is to say, the total vector length is divided into divided vector lengths of 256, 194, 192, 192, and 192. In this way, the vector computation processor can perform vector computation with high efficiency.

A division method of (B) will now be described.

The division unit 2 divides the total vector length into the divided vector lengths with use of costs that are respectively associated with chunk vector lengths that have been divided using the maximum vector length as a reference. The chunk vector lengths are set based on, for example, the number of vector pipelines.

The division unit 2 determines the divided vector lengths with use of the total vector length VL_{Total}, the maximum vector length VL_{Max}, the chunk vector lengths, and the costs that are respectively set for the chunk vector lengths, and calculates the number Yj of each of the determined divided vector lengths.

For example, in a case where the total vector length VL_{Total}=1026, the maximum vector length VL_{Max}=256, and the number of vector pipelines is 32, the number of the chunk vector lengths is 8 (=256/32). That is to say, the chunk vector lengths j (=1, . . . , 8) are 32, 64, 96, 128, 160, 192, 224, and 256.

Also, the costs Cj are respectively set for the chunk vector lengths j. For example, the costs C1 . . . C6=9.0 [s], the cost C7=10.0 [s], and the cost C8=10.9 [s] are respectively set for the chunk vector lengths j (=1 . . . 8).

Note that the costs for respective chunk vector lengths are set based on the computation periods of respective chunk vector lengths. Specifically, vector computation is executed through an experiment, a simulation, and the like with respect to each of chunk vector lengths from the minimum vector length (one element) to the maximum vector length, the computation periods of respective chunk vector lengths are measured, and the measured computation periods are used as the costs of respective chunk vector lengths.

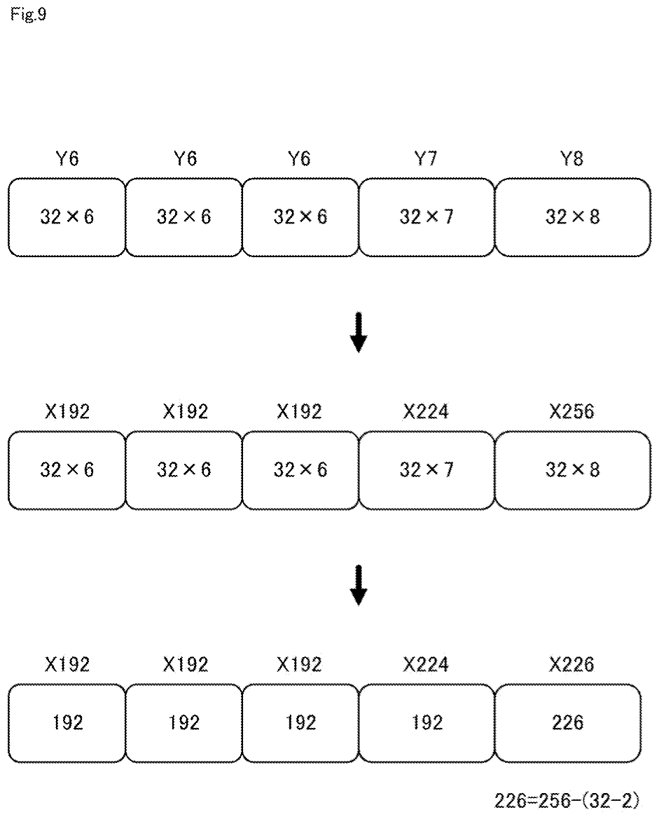

Subsequently, the division unit 2 determines the divided vector lengths as illustrated in FIG. 9 and Math. 3. FIG. 9 is a diagram illustrating one example of calculation of the divided vector lengths that uses the chunk vector lengths. Note that as the total vector length 1026 cannot be divided exactly by 32 (1026/32=32 and a remainder of 2), 32 is rounded up to 33 with use of a remainder of 2.

Variable: Yj (j=1,2, . . . ,8)

Objective function: sum(Cj×Yj)

Constraint condition: Yj≥0, sum(j×Yj)=33 (Math. 3)

The number of each chunk vector length:
Y1=0
Y2=0
Y3=0
Y4=0
Y5=0
Y6=3
Y7=1
Y8=1

The number for each divided vector length:
X192=3
X224=1
X256=1→X226=1*
*X226: 256−(32−2)=226

That is to say, the total vector length is divided into divided vector lengths of 192, 192, 192, 224, and 256. In this way, the vector computation processor can perform vector computation with high efficiency.

In the system 50 illustrated in FIG. 5 or the system 60, the generation unit 3 generates codes to be used in vector computation based on the divided vector lengths determined by the division unit 2. Specifically, the generation unit 3 first obtains information related to the divided vector lengths from the division unit 2. Subsequently, using the obtained information related to the divided vector lengths, the generation unit 3 generates codes to be used in vector computation.

[Apparatus Operations]

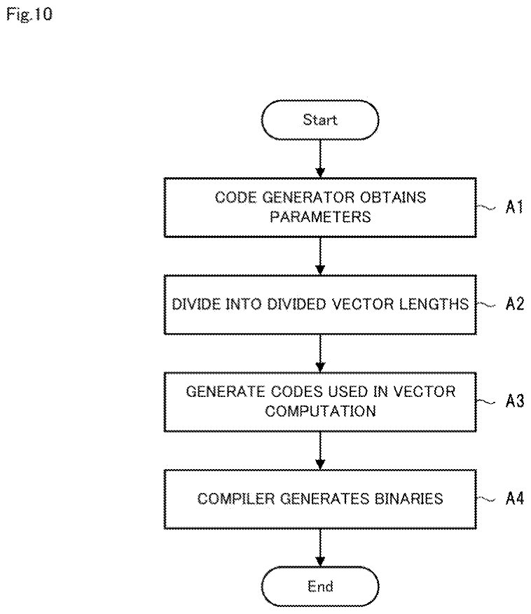

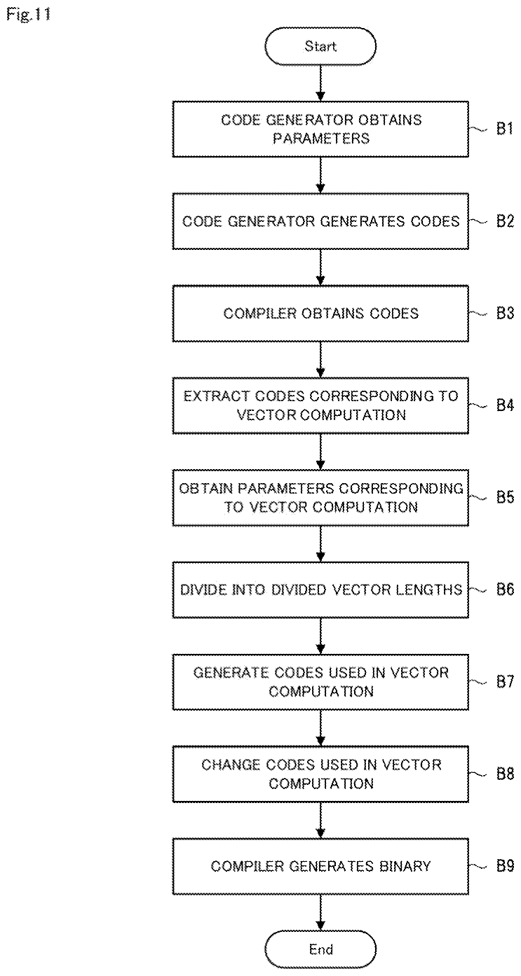

Next, the operations of the optimization apparatus according to the example embodiment of the present invention will be described using FIGS. 10 and 11. FIGS. 10 and 11 are diagrams illustrating examples of system operations. In the following description, FIGS. 1 to 9 will be referred to as appropriate. Also, in the present example embodiment, an optimization method is executed by causing the optimization apparatus to operate. Therefore, the following description of the operations of the optimization apparatus applies to the optimization method according to the present example embodiment.

(1) The operations of the system 50 will now be described.

The operations of the optimization apparatus 1 in the system 50 illustrated in FIG. 5 will be described using FIG. 10. As illustrated in FIG. 10, first, the code generator 51 generates codes based on the input data 53 (step A1). Specifically, in step A1, the code generator 51 obtains the data 53, which includes parameters used in vector computation. The parameters to be used in vector computation are, for example, data that includes the total vector length, the maximum vector length, and the like.

Subsequently, the division unit 2 included in the code generator 51 performs division to create divided vector lengths with which the computation efficiency becomes equal to or higher than the predetermined value (step A2). Specifically, in step A2, the division unit 2 first obtains the parameters related to vector computation (e.g., the total vector length, the maximum vector length, and the like). Subsequently, using the costs that are stored in the non-illustrated storage unit in advance, the division unit 2 divides the total vector length into the divided vector lengths that are equal to or shorter than the maximum vector length so that the computation efficiency becomes equal to or higher than the predetermined value. The storage unit may be provided in the system 50 or 60, or may be provided outside the system 50 or 60.

For example, in step A2, the division unit 2 (A) divides the total vector length into the divided vector lengths with use of costs that are respectively associated with vector lengths.

Alternatively, in step A2, the division unit 2 (B) divides the total vector length into the divided vector lengths with use of costs that are respectively associated with chunk vector lengths that have been divided using the maximum vector length as a reference.

Subsequently, the generation unit 3 included in the code generator 51 generates codes for vector computation based on the determined divided vector lengths (step A3). Specifically, in step A3, the generation unit 3 first obtains information related to the divided vector lengths from the division unit 2. Subsequently, using the obtained information related to the divided vector lengths, the generation unit 3 generates codes used in vector computation. Thereafter, the code generator 51 outputs the codes 54, which includes the codes to be used in vector computation, to the compiler 52.

Subsequently, the compiler 52 generates the binaries 55 based on the obtained codes 54. Specifically, using the codes 54 generated by the code generator 51, the compiler 52 generates the binaries 55 used in the vector computation processor (step A4).

(2) The operations of the system 60 will now be described.

The operations of the optimization apparatus 1 in the system 60 illustrated in FIG. 8 will be described using FIG. 11. As illustrated in FIG. 11, first, the code generator 61 generates codes based on the input data 53 (step B1). Specifically, in step B1, the code generator 61 obtains the data 53, which includes input parameters and the like.

Subsequently, the code generator 61 generates the codes 63 to be used to generate the binary 55 to be used in the vector computation processor (step B2).

Subsequently, the compiler 62 obtains the codes 63 from the code generator 61 (step B3). Subsequently, the extraction unit 64 included in the compiler 62 extracts codes corresponding to vector computation (step B4). Subsequently, the extraction unit 64 extracts parameters to be used to determine the divided vector lengths from the extracted codes (step B4). Thereafter, the extraction unit 64 outputs the extracted parameters to the division unit 2.

Subsequently, the division unit 2 included in the compiler 62 obtains parameters related to vector computation (step B5). Subsequently, using the costs, the division unit 2 divides the total vector length into the divided vector lengths that are equal to or shorter than the maximum vector length so that the computation efficiency becomes equal to or higher than the predetermined value (step B6).

Specifically, in step B6, the division unit 2 first obtains the parameters related to vector computation (e.g., the total vector length, the maximum vector length, and the like). Subsequently, using the costs that are stored in the non-illustrated storage unit in advance, the division unit 2 divides the total vector length into the divided vector lengths that are equal to or shorter than the maximum vector length so that the computation efficiency becomes equal to or higher than the predetermined value. The storage unit may be provided in the system 50 or 60, or may be provided outside the system 50 or 60.

For example, in step B6, the division unit 2 (A) divides the total vector length into the divided vector lengths with use of costs that are respectively associated with vector lengths.

Alternatively, in step B6, the division unit 2 (B) divides the total vector length into the divided vector lengths with use of costs that are respectively associated with chunk vector lengths that have been divided using the maximum vector length as a reference.

Subsequently, the generation unit 3 included in the compiler 62 generates codes 54 for vector computation based on the determined divided vector lengths (step B7). Specifically, in step B7, the generation unit 3 first obtains information of the divided vector lengths and the like from the division unit 2. Subsequently, using the obtained information of the divided vector lengths and the like, the generation unit 3 generates codes used in vector computation.

Subsequently, the changing unit 65 generates the codes 54 by changing the codes which are included in the codes 63 generated by the code generator 61 and which have been extracted to be used in vector computation, into the codes which have been generated by the compiler 62 to be used in vector computation (step B8). Thereafter, the changing unit 65 outputs the codes 54 to the compiler 62.

Subsequently, using the codes 63 generated by the code generator 61, the compiler 62 generates the binary 55 to be used in the vector computation processor (step B9).

[Effects of Present Example Embodiment]

As described above, according to the present example embodiment, the vector computation processor executes vector computation in units of the divided vector lengths, with which the computation efficiency of vector computation becomes equal to or higher than the predetermined value and which have been divided to be equal to or shorter than the maximum vector length; therefore, the computation efficiency can be improved.

Furthermore, with use of the costs, it is possible to generate the divided vector lengths with which the computation efficiency of vector computation becomes equal to or higher than the predetermined value and which have been divided to be equal to or shorter than the maximum vector length.

[Program]

It is sufficient that a program according to the example embodiment of the present invention be a program that causes a computer to execute steps A1 to A4 illustrated in FIG. 10, or steps B1 to B9 illustrated in FIG. 11. The optimization apparatus and the optimization method according to the present example embodiment can be realized by installing this program in the computer and executing this program. In this case, a processor of the computer functions and performs processing as the division unit 2 and generation unit 3 illustrated in FIG. 5, or the division unit 2, generation unit 3, extraction unit 64, and changing unit 65 illustrated in FIG. 4.

Also, the program according to the present example embodiment may be executed by a computer system constructed by a plurality of computers. In this case, for example, each computer may function as one of the division unit 2, generation unit 3, extraction unit 64, and changing unit 65.

[Physical Configuration]

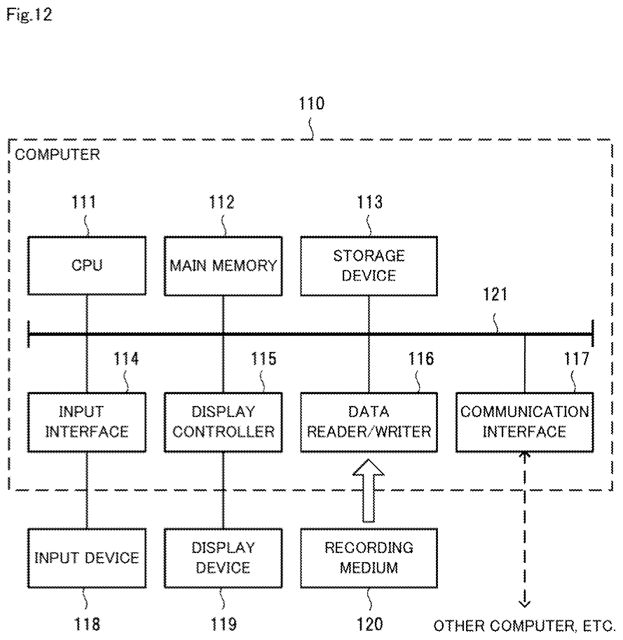

Using FIG. 12, a description is now given of the computer that realizes the optimization apparatus by executing the program according to the example embodiment. FIG. 12 is a block diagram illustrating one example of the computer that realizes the optimization apparatus according to the example embodiment of the present invention.

As illustrated in FIG. 12, a computer 110 includes a CPU 111, a main memory 112, a storage device 113, an input interface 114, a display controller 115, a data reader/writer 116, and a communication interface 117. These components are connected in such a manner that they can perform data communication with one another via a bus 121. Note that the computer 110 may include a GPU (Graphics Processing Unit) or an FPGA (Field-Programmable Gate Array) in addition to the CPU 111 or in place of the CPU 111.

The CPU 111 executes various types of computation by deploying the program (codes) according to the present example embodiment stored in the storage device 113 to the main memory 112, and executing the deployed program in a predetermined order. The main memory 112 is typically a volatile storage device, such as a DRAM (Dynamic Random Access Memory). Also, the program according to the present example embodiment is provided in a state where it is stored in a computer readable recording medium 120. Note that the program according to the present example embodiment may be distributed over the Internet connected via the communication interface 117.

Furthermore, specific examples of the storage device 113 include a hard disk drive and also a semiconductor storage device, such as a flash memory. The input interface 114 mediates data transmission between the CPU 111 and an input device 118, such as a keyboard and a mouse. The display controller 115 is connected to a display apparatus 119, and controls displays on the display apparatus 119.

The data reader/writer 116 mediates data transmission between the CPU 111 and the recording medium 120, and executes readout of the program from the recording medium 120, as well as writing of the result of processing in the computer 110 to the recording medium 120. The communication interface 117 mediates data transmission between the CPU 111 and another computer.

Also, specific examples of the recording medium 120 include: a general-purpose semiconductor storage device, such as CF (Compact Flash®) and SD (Secure Digital); a magnetic recording medium, such as a flexible disk; and an optical recording medium, such as CD-ROM (Compact Disk Read Only Memory).

Note that the optimization apparatus 1 according to the present example embodiment can also be realized using items of hardware corresponding to respective components, rather than using the computer with the program installed therein. Furthermore, a part of the optimization apparatus 1 may be realized by the program, and the remaining part of the optimization apparatus 1 may be realized by hardware.

[Supplementary Notes]

In relation to the foregoing example embodiment, the following Supplementary Notes are further disclosed. A part or an entirety of the foregoing example embodiment can be described as, but is not limited to, the following description of (Supplementary Note 1) to (Supplementary Note 15).

(Supplementary Note 1)

An optimization apparatus, including:

a division unit configured to divide a total vector length into divided vector lengths that are equal to or shorter than a maximum vector length so that computation efficiency becomes equal to or higher than a predetermined value in vector computation to be executed by a vector computation processor; and

a generation unit configured to generate a code to be used in the vector computation based on the divided vector lengths.

(Supplementary Note 2)

The optimization apparatus according to Supplementary Note 1,

wherein the division unit divides the total vector length into the divided vector lengths with use of costs that are respectively associated with vector lengths.

(Supplementary Note 3)

The optimization apparatus according to Supplementary Note 1,

wherein the division unit divides the total vector length into the divided vector lengths with use of costs that are respectively associated with chunk vector lengths that have been divided using the maximum vector length as a reference.

(Supplementary Note 4)

The optimization apparatus according to Supplementary Note 2 or 3, wherein the costs are set based on the code or a vector computation period.

(Supplementary Note 5)

The optimization apparatus according to any one of Supplementary Notes 1 to 4,

an extraction unit configured to, in a case where a code to be used in the vector computation is generated by a compiler, extract a code corresponding to the vector computation.

(Supplementary Note 6)

An optimization method, comprising:

(a) a step of dividing a total vector length into divided vector lengths that are equal to or shorter than a maximum vector length so that computation efficiency becomes equal to or higher than a predetermined value in vector computation to be executed by a vector computation processor; and

(b) a step of generating a code to be used in the vector computation based on the divided vector lengths.

(Supplementary Note 7)

The optimization method according to Supplementary Note 6,

wherein in the (a) step, the total vector length is divided into the divided vector lengths with use of costs that are respectively associated with vector lengths.

(Supplementary Note 8)

The optimization method according to Supplementary Note 6,

wherein in the (a) step, the total vector length is divided into the divided vector lengths with use of costs that are respectively associated with chunk vector lengths that have been divided using the maximum vector length as a reference.

(Supplementary Note 9)

The optimization method according to Supplementary Note 7 or 8,

wherein the costs are set based on the code or a vector computation period.

(Supplementary Note 10)

The optimization method according to any one of Supplementary Notes 6 to 9, including:

(c) a step of, in a case where a code used in the vector computation is generated by a compiler, extracting a code corresponding to the vector computation.

(Supplementary Note 11)

A computer readable recording medium having recorded therein a program including an instruction that causes a computer to execute:

(a) a step of dividing a total vector length into divided vector lengths that are equal to or shorter than a maximum vector length so that computation efficiency becomes equal to or higher than a predetermined value in vector computation to be executed by a vector computation processor; and

(b) a step of generating a code to be used in the vector computation based on the divided vector lengths.

(Supplementary Note 12)

The computer readable recording medium according to Supplementary Note 11,

wherein in the (a) step, the total vector length is divided into the divided vector lengths with use of costs that are respectively associated with vector lengths.

(Supplementary Note 13)

The computer readable recording medium according to Supplementary Note 11,

wherein in the (a) step, the total vector length is divided into the divided vector lengths with use of costs that are respectively associated with chunk vector lengths that have been divided using the maximum vector length as a reference.

(Supplementary Note 14)

The computer readable recording medium according to Supplementary Note 12 or 13,

wherein the costs are set based on the code or a vector computation period.

(Supplementary Note 15)

The computer-readable recording medium according to any one of Supplementary Notes 11 to 14,

wherein the program further includes an instruction that causes the computer to execute:

(c) a step of, in a case where the code used in the vector computation is generated by a compiler, extracting a code corresponding to the vector computation.

Although the invention of the present application has been described above with reference to the example embodiment, the invention of the present application is not limited to the foregoing example embodiment. Various changes that can be construed by a person skilled in the art can be made to the configurations and details of the invention of the present application within the scope of the invention of the present application.

### INDUSTRIAL APPLICABILITY

As described above, according to the present invention, the computation efficiency of vector computation can be improved. The present invention is useful in the fields that require vector computation.

### REFERENCE SIGNS LIST

1 optimization apparatus
2 division unit
3 generation unit
50 system
51 code generator
52 compiler
53 data
54 code
55 binary
60 system
61 code generator
62 compiler
63 code
64 extraction unit
65 changing unit
110 computer
111 CPU
112 main memory
113 storage device
114 input interface
115 display controller
116 data reader/writer
117 communication interface
118 input device
119 display apparatus
120 recording medium
121 bus

What is claimed is:

1. An optimization apparatus, comprising:
a division unit configured to divide a total vector length into divided vector lengths that are equal to or shorter than a maximum vector length so that computation efficiency becomes equal to or higher than a predetermined value in vector computation to be executed by a vector computation processor; and
a generation unit configured to generate a code to be used in the vector computation based on the divided vector lengths.

2. The optimization apparatus according to claim 1,
wherein the division unit divides the total vector length into the divided vector lengths with use of costs that are respectively associated with vector lengths.

3. The optimization apparatus according to claim 1,
wherein the division unit divides the total vector length into the divided vector lengths with use of costs that are respectively associated with chunk vector lengths that have been divided using the maximum vector length as a reference.

4. The optimization apparatus according to claim 2,
wherein the costs are set based on the code or a vector computation period.

5. The optimization apparatus according to claim 2,
an extraction unit configured to, in a case where a code to be used in the vector computation is generated by a compiler, extracting a code corresponding to the vector computation.

6. An optimization method, comprising:
dividing a total vector length into divided vector lengths that are equal to or shorter than a maximum vector length so that computation efficiency becomes equal to or higher than a predetermined value in vector computation to be executed by a vector computation processor; and
generating a code to be used in the vector computation based on the divided vector lengths.

7. The optimization method according to claim 6,
wherein in the dividing, the total vector length is divided into the divided vector lengths with use of costs that are respectively associated with vector lengths.

8. The optimization method according to claim 6,
wherein in the dividing, the total vector length is divided into the divided vector lengths with use of costs that are respectively associated with chunk vector lengths that have been divided using the maximum vector length as a reference.

9. The optimization method according to claim 7,
wherein the costs are set based on the code or a vector computation period.

10. The optimization method according to claim 6, comprising:
in a case where a code used in the vector computation is generated by a compiler, extracting a code corresponding to the vector computation.

11. A non-transitory computer readable recording medium having recorded therein a program including an instruction that causes a computer to execute:
dividing a total vector length into divided vector lengths that are equal to or shorter than a maximum vector length so that computation efficiency becomes equal to or higher than a predetermined value in vector computation to be executed by a vector computation processor; and
generating a code to be used in the vector computation based on the divided vector lengths.

12. The non-transitory computer readable recording medium according to claim 11,
wherein in the dividing, the total vector length is divided into the divided vector lengths with use of costs that are respectively associated with vector lengths.

13. The non-transitory computer readable recording medium according to claim 11,
wherein in the dividing, the total vector length is divided into the divided vector lengths with use of costs that are respectively associated with chunk vector lengths that have been divided using the maximum vector length as a reference.

14. The non-transitory computer readable recording medium according to claim 12,
wherein the costs are set based on the code or a vector computation period.

15. The non-transitory computer-readable recording medium according to claim 11,
wherein the program further includes an instruction that causes the computer to execute:
in a case where the code used in the vector computation is generated by a compiler, extracting a code corresponding to the vector computation.
